(19) United States
(12) Patent Application Publication
(10) Pub. No.: US 2014/0015405 A1
(43) Pub. Date: Jan. 16, 2014

(54) LIGHT EMITTING DIODE MODULE

(71) Applicant: Ting-Kuo HSIN, Taipei City (TW)

(72) Inventor: Ting-Kuo HSIN, Taipei City (TW)

(73) Assignee: Elementech International Co., Ltd.

(21) Appl. No.: 13/547,059

(22) Filed: Jul. 12, 2012

(51) Int. Cl. H01J 7/44

(52) U.S. Cl. 315/71

(57) ABSTRACT

The light emitting diode module is disclosed. The light emitting diode module includes a ceramic substrate, a circuit layer, at least an illuminant element and a driving circuit element. The ceramic substrate has a recess formed on and upper surface thereof. The circuit layer is placed on the upper surface of the ceramic substrate. The driving circuit element is disposed on the upper surface of the ceramic substrate and electrically connected to the circuit layer.

By providing the recess at molding of the ceramic substrate, the light emitting diode module can prevent manufacturing difficulty from hardness ceramic substrate. In addition, by accommodating the adhesive in the recess, the adhesive can be easily orientated and of convex shape.

### BACKGROUND OF THE INVENTION

1. Field of the Invention

The present invention relates to a lighting module, especially to a light module using light emitting diode as light source.

2. Description of Prior Art

Light emitting diode is gradually becoming an important role in the lighting field by the advantage of lower consumption. In order to replace the consumption incandescent lamps, light emitting diode has to use more simple structure or manufacture to lose manufacture costs that consumer affordable.

In recently, light emitting diode bulbs has used the chip on board manner. It directly disposes the light emitting diode dies on the circuit board, and abandons the manner used in the past of packaging the light emitting diode first, and then disposed the packaged light emitting diode on the circuit board.

Moreover, in order to quickly dissipate heat generated by the operating light emitting diode dies, aluminum substrate and ceramic substrate is in common use for dissipating heat. The aluminum substrate is covered with an isolating layer and a circuit layer in sequence. The isolating layer is used for electrical isolating the circuit layer and the aluminum substrate, however, it has poor thermal conductivity, in the result, the heat dissipating is not good as expectation. The ceramic substrate has difficulty in processing into structures like recess, in the result, fluorescent glue or adhesive cannot be fixed by the recess, and the reflecting angle of light emitting by the light emitting diode cannot be controlled to achieve demanded illuminant angle, either.

Furthermore, the conventional light emitting diode bulb disposes a driving circuit with larger volume and heavy weight in a housing thereof and connected to the driving circuit via wires, in this result, the housing has to reserve a considerable internal space for accommodating the driving circuit.

### SUMMARY OF THE INVENTION

It is an object of the present invention to provide a light emitting diode module, the light emitting diode module provides a ceramic substrate with a recess by sintering, and directly package illuminant elements in the recess for controlling the reflecting angle of the illuminant element and reach a demanded illuminant angle.

Accordingly, the light emitting diode module of the present invention includes a ceramic substrate, a circuit layer, at least an illuminant element and a driving circuit element. The ceramic substrate has a recess on an upper surface thereof. The circuit layer is placed on the upper surface of the ceramic substrate. The illuminant element is disposed in the recess and electrically connected to the circuit layer. The driving circuit element is disposed on the ceramic substrate and electrically connected to the circuit layer.

By sintering ceramic powder and using suitable mold, the recess can be formed on the ceramic substrate at molding to avoid manufacturing difficulty from ceramic substrate of high hardness. By accommodating the adhesive in the recess, the adhesive can be easily orientated or positioned and formed with substantially convex shape.

### BRIEF DESCRIPTION OF DRAWINGS

The features of the invention believed to be novel are set forth with particularity in the appended claims. The invention itself however may be best understood by reference to the following detailed description of the invention, which describes certain exemplary embodiments of the invention, taken in conjunction with the accompanying drawings in which:

FIG. 1 is a perspective view of a light emitting diode module according to a first embodiment of the present invention.

FIG. 2 is a sectional view of the light emitting diode module according to the first embodiment of the present invention.

FIG. 3 is a perspective view of a light emitting diode module according to a second embodiment of the present invention.

### DETAILED DESCRIPTION OF THE INVENTION

Reference will now be made in detail to the present embodiments of the invention, examples of which are illustrated in the accompanying drawings. Wherever possible, the same reference numbers are used in the drawings and the description to refer to the same or like parts.

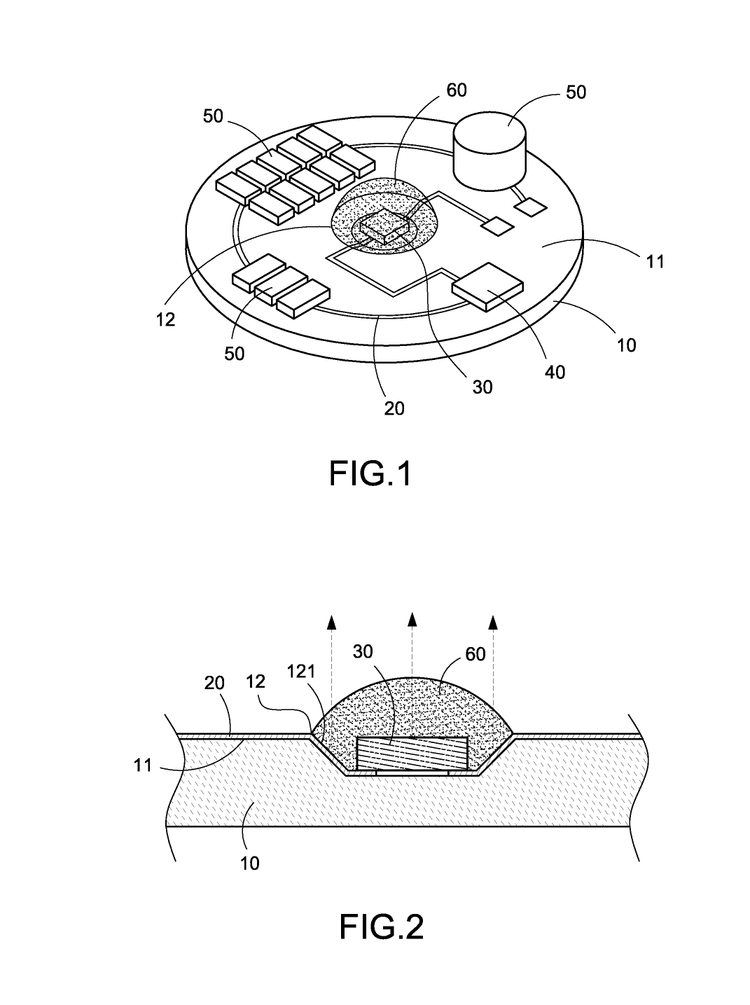

Reference is made to FIG. 1, which is a perspective view of a light emitting diode module according to a first embodiment of the present invention. The light emitting diode module includes a ceramic substrate 10, a circuit layer 20, an illuminant element 30, a driving circuit element 40 and a plurality of electrical elements 50.

The ceramic substrate 10 has a recess 12 formed on an upper surface 11 thereof. The ceramic substrate 10 is made of ceramic powder by sintering. By using appreciate mold, the recess 12 can be formed at the molding of the ceramic substrate 10 without any other subsequent procedure to fabricate the recess on an ordinary flat ceramic material, and this can avoid manufacturing difficulty on ceramic substrate with high hardness.

The circuit layer 20 is placed on the upper surface 11 of the ceramic substrate 10. The circuit layer 20 may be made of copper or other material with electrical conductive, and the circuit layer 20 is formed on the ceramic substrate 10 by cofiring. In more particularly, the manufacturing method of the circuit layer formed on the ceramic substrate 10 may use thick film or thin film technology by high temperature sintering. The sintering temperature must be lower than the melting point of the ceramic substrate 10. The circuit layer 20 is extended into the recess 12 and formed with two independent contacts on the bottom of the recess 12.

The illuminant element 30 is disposed in the recess 12 and electrically connected to the contacts disposed in the recess 12. The illuminant element 30 is, for example, flip-chip type light emitting diode (LED) die. In the practical application, the illuminant element 30 may be LED die with electrodes arranged in horizontal type or vertical type, and electrically connected to the circuit layer 20 by wire-bonding.

The driving circuit element 40 is disposed on the upper surface 11 of the ceramic substrate 10 and electrically connected to the circuit layer 20, so that the illuminant element 30 can be driven and lighted by the driving circuit element 40 via the circuit layer 20. In addition, the electrically elements 50 may be resistor, capacitor or other passive electrical element. By directly placing the driving circuit element 40 on the ceramic substrate 10, a bulb lamp with the light emitting diode module of the present invention can dispense with additionally dispose driving circuit within a housing, which can effectively save space and reduce the volume of the bulb lamp and cost.

The light emitting diode module further includes an adhesive 60 disposed in the recess 12. The adhesive 60 is light-transparent. In the practical application, the adhesive 60 may further includes fluorescent materials with function of converting the wavelength of light, thus converting partial light color emitted by the illuminant element 30.

The recess 12 is used for accommodating the adhesive 60, so that the adhesive 60 dripped on the ceramic substrate 10 can be easily orientated or positioned by the recess 12, and the adhesive 60 is substantially of convex shape, this means the adhesive 60 can be a first lens of the illuminant element 30.

Reference is made to FIG. 2, which is a sectional view of the light emitting diode module according to the first embodiment of the present invention. In more particularly, the recess 12 has a circumferential surface 121, and an obtuse face is formed between the circumferential surface 121 and the upper surface 11 of the ceramic substrate 10, so that the light emitted by the illuminant element 30 can be upwardly reflected by the circumferential surface 121 for increasing luminous efficiency of the light emitting diode module.

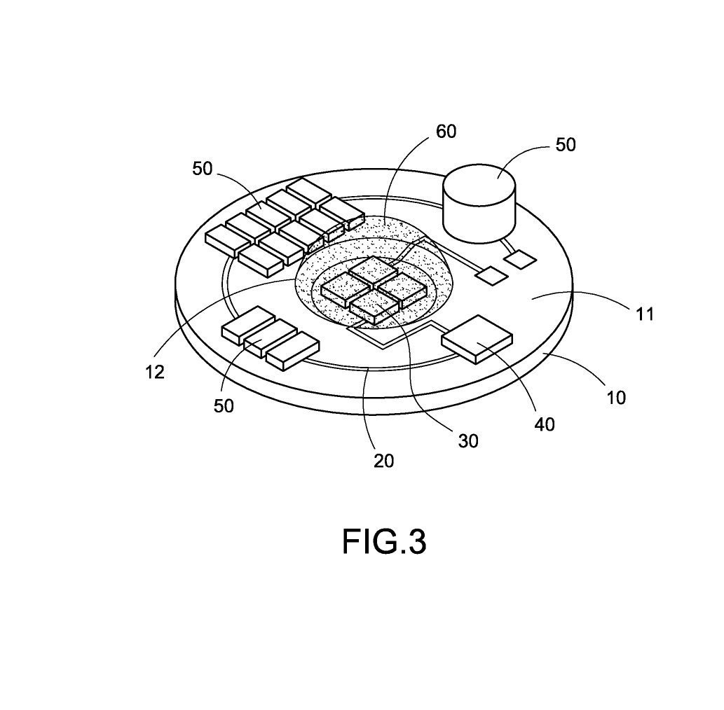

Referenced is made to FIG. 3, which is a perspective view of a light emitting diode module according to a second embodiment of the present invention. The light emitting diode module is similar to the first embodiment mentioned above. The difference is that the light emitting diode module in this embodiment includes a plurality of illuminant elements 30 disposed in the recess 12 and electrically connected to the circuit layer 20. By placing the illuminant elements 30 in the recess 12 and covering the illuminant elements 30 with the adhesive 60, the illuminant intensity can be increased and satisfy the demand of high brightness.

To sum up, by sintering ceramic powder and using suitable mold, the recess can be formed on the ceramic substrate 10 at molding to avoid manufacturing difficulty from ceramic substrate of high hardness. By accommodating the adhesive 60 in the recess 12, the adhesive 60 can be easily orientated or positioned and formed with substantially convex shape. In addition, by disposing the driving circuit element 40 on the ceramic substrate 10, a bulb lamp with the light emitting diode module of the present invention can dispense with driving circuit within a housing, which can effectively save space and reduce the volume of the bulb lamp and cost.

Although the present invention has been described with reference to the preferred embodiment thereof, it will be understood that the invention is not limited to the details thereof. Various substitutions and modifications have suggested in the foregoing description, and other will occur to those of ordinary skill in the art. Therefore, all such substitutions and modifications are intended to be embraced within the scope of the invention as defined in the appended claims.

What is claimed is:

1. A light emitting diode module comprises:
a ceramic substrate including a recess in an upper surface thereof;
a circuit layer placed on the upper surface of the ceramic substrate;
at least a illuminant element disposed in the recess and electrically connected to the circuit layer, and
a driving circuit element disposed on the ceramic substrate and electrically connected to the circuit layer.

2. The light emitting diode module in the claim 1, wherein the ceramic substrate is made of ceramic powder by sintering.

3. The light emitting diode module in claim 1, wherein the circuit layer is formed on the ceramic substrate by cofiring.

4. The light emitting diode module in claim 1, wherein the recess has an obtuse face formed between the circumferential surface and the upper surface.

5. The light emitting diode module in claim 1, wherein the circuit layer is extended from the upper surface of the ceramic substrate to recess.

6. The light emitting diode module in claim 1, further comprising an adhesive disposed in the recess.

7. The light emitting diode module in claim 6, wherein the adhesive further comprises fluorescent material.

8. The light emitting diode module in claim 1, further comprising a plurality of illuminant elements disposed in the recess and electrically connected to the circuit layer.
